(19) United States
(12) Patent Application Publication
(10) Pub. No.: US 2017/0313420 A1
(43) Pub. Date: Nov. 2, 2017

(54) AUTONOMOUS SPRAY SHIP AND METHOD

(71) Applicant: Spray Ship Corporation, Fargo, ND (US)

(72) Inventors: Terry Anderson, Brookings, SD (US); Robert S. Cornelius, St. Paul, MN (US); Patrick D. O'Malley, River Falls, WI (US); Isaac Braun, Edina, MN (US)

(21) Appl. No.: 15/528,440

(22) PCT Filed: Nov. 19, 2015
(86) PCT No.: PCT/US15/61652

§ 371 Date: May 19, 2017

Related U.S. Application Data
(60) Provisional application No. 62/081,878, filed on Nov. 19, 2014.

(51) Int. Cl. B64D 1/18; B64B 1/24; B64D 27/24; B64D 31/06; B64F 1/00; A01M 7/00; A01M 21/04; G01C 15/00; G01S 13/46; B64C 39/02; B64D 27/02

(52) U.S. Cl. CPC B64D 1/18; A01M 21/043; B64B 1/24; B64D 27/24; B64D 31/06; G01C 15/00; B64F 1/00; A01M 7/0089; B64C 39/024; B64C 2201/022; B64C 2201/042; B64C 2201/141; B64D 2027/026; G01S 13/46; B64C 2201/208

(57) ABSTRACT

An airship and method of providing thrust to an airship are shown. Examples include a number of turbine thrusters coupled to a number of electric motor/generators that supplement thrust from the turbine thrusters. Systems and methods are described that include surveying an agricultural area, and spraying an amount of an agricultural supply on only selected portion of the agricultural area.

### CLAIM OF PRIORITY

This application claims the benefit of priority to U.S. Provisional Patent Application No. 62/081,878, filed on Nov. 19, 2014, which is incorporated by reference herein in its entirety.

### TECHNICAL FIELD

Various embodiments described herein relate to apparatus, systems, and methods associated with thrusters. In one example, the thrusters are used to power airships. In specific examples, airships are used for agricultural spraying.

### BACKGROUND

In some machines, such as airships, traditional thrust control using a throttle may not provide sufficient reaction time for desired changes in thrust. Improved designs and methods are desired to address this and other shortcomings. More specifically, in agriculture, spraying a field, for any of a number of reasons is often desirable. Labor and product costs for spraying are large. It is desirable to provide devices and methods that automate some or all of the spraying process to reduce the amount of human labor needed. It is also desirable to reduce the amount of product being sprayed.

### BRIEF DESCRIPTION OF THE DRAWINGS

FIG. 1 shows an isometric view of an airship according to an embodiment of the invention.

FIG. 2 shows a side view of an agricultural spray system according to an embodiment of the invention.

FIG. 3 shows a flow diagram of a method of agricultural spraying according to an embodiment of the invention.

FIG. 4A shows a top view of an airship according to an embodiment of the invention.

FIG. 4B shows a side cross section view of an airship according to an embodiment of the invention.

FIG. 4C shows a schematic block diagram of portions of an airship according to an embodiment of the invention.

FIG. 5 shows a flow diagram of a method of controlling an airship according to an embodiment of the invention.

### DETAILED DESCRIPTION

In the following detailed description of the invention, reference is made to the accompanying drawings that form a part hereof and in which are shown, by way of illustration, specific embodiments in which the invention may be practiced. These embodiments are described in sufficient detail to enable those skilled in the art to practice the invention. Other embodiments may be utilized and structural, logical, and electrical changes may be made.

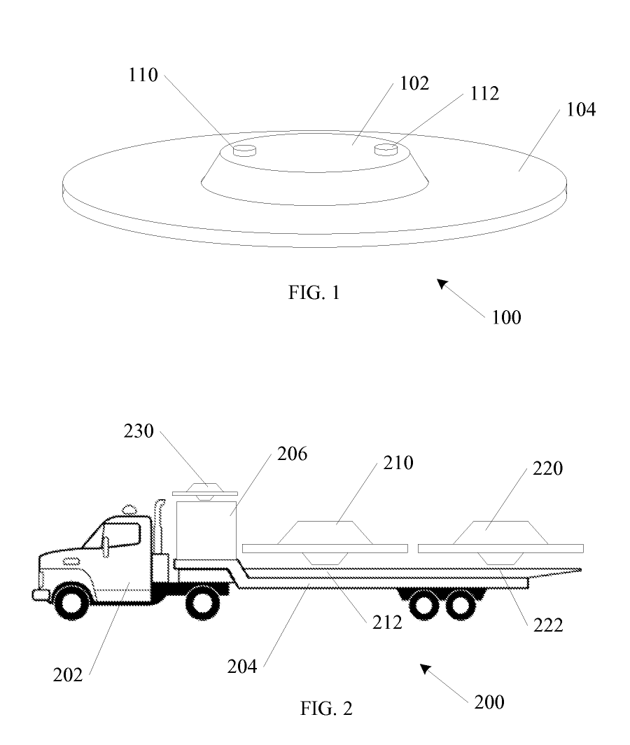

FIG. 1 shows an example of an airship 100. The airship 100 includes a body portion 102 and a periphery 104. In one example, the airship 100 includes an autonomous navigational positioning system. In the example shown in FIG. 1, the airship 100 includes a first transceiver 110 and a second transceiver 112. In selected examples, a pair of transceivers 110, 112, spaced apart from one another, provide precise distance data to fixed locations around a region, such as an agricultural field. In one example, triangulation of distance data from a pair of transceivers 110, 112 provides orientation and location information to the airship 100 that may be used for navigation within an area, such as an agricultural field.

Examples of transceivers may include, but are not limited to, laser or other optical transceivers, radio frequency transceivers, interferometry based transceivers, etc. In one example, a single transceiver may be used, instead of a pair.

In one example, a pair of transceivers are used, where a first transceiver is capable of providing all necessary orientation and location data, and a second transceiver provides a cross check to the first transceiver. Using a cross check example may aid in ensuring that navigation of the airship is not based on incorrect orientation or location information, which may lead to unwanted collisions or crashing of the airship.

In the example of FIG. 1, the airship 100 is shown as generally round, although the invention is not so limited. In other examples, square shapes, oval shapes, or any suitable geometry may be used.

In one example, the airship 100 includes a reservoir configured to hold an agricultural product, such as insecticide, herbicide, fertilizer, water, etc. Although an agricultural application is described as one example use, airships and methods as described in the present disclosure may be used for any number of other end use applications such as transportation, remote camera operation, military applications, etc.

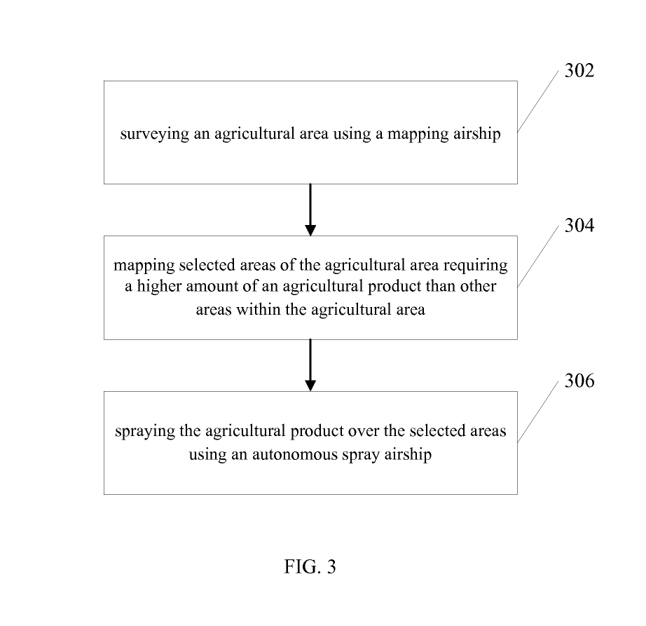

FIG. 2 shows an example of an agricultural spray system 200 according to an embodiment of the invention. A first airship 210 and a second airship 220 are shown. Although a pair of airships are shown in the example of FIG. 2, the invention is not so limited. A single airship may be used, or more than two airships may be used. One advantage of more than one airships includes the ability for one airship to be working a field, while other airships are refueled and/or resupplied with an agricultural product.

In the example shown, the first airship 210 is mounted to a trailer 204 at a first docking station 212. The second airship 220 is likewise mounted to the trailer 204 at a second docking station 222. In the example shown, a trailer 204 is pulled by a vehicle 202 such as a truck, tractor, or other vehicle. In other examples, the agricultural spray system 200 is in a permanent location. One example of a mobile agricultural spray system 200 includes the ability to service more than one field as needed by moving the system from one location to another.

As described in examples above, in one embodiment, each airship includes a reservoir configured to hold an agricultural product. In one example, the agricultural spray system 200 includes a second reservoir 206 that is larger than the reservoirs of the airships. In one example the second reservoir 206 includes an agricultural product as described above. In one example, the second reservoir 206 includes multiple reservoirs with different agricultural products, and may include fuel for an airship, such as diesel fuel.

In operation, one or more airships may deliver their payload of agricultural product to a field, and return to a respective docking station to resupply agricultural product and/or to refuel. In examples with a plurality of airships, one airship may be delivering a payload of agricultural product to a field while one or more other airships are resupplying.

In one example, the agricultural spray system 200 includes a mapping airship 230. In one example, the mapping airship 230 does not carry any agricultural product, and is used to survey an area for targeted application of agricultural product by one or more of the other airships 210, 220. In one example the mapping airship 230 includes thrust systems similar to the other airships 210, 220 as described in more detail below. In one example, because the mapping airship 230 need not carry as much weight as the other airships 210, 220, the mapping airship 230 may be battery powered, and may be recharged periodically with a charging station located on the trailer 204.

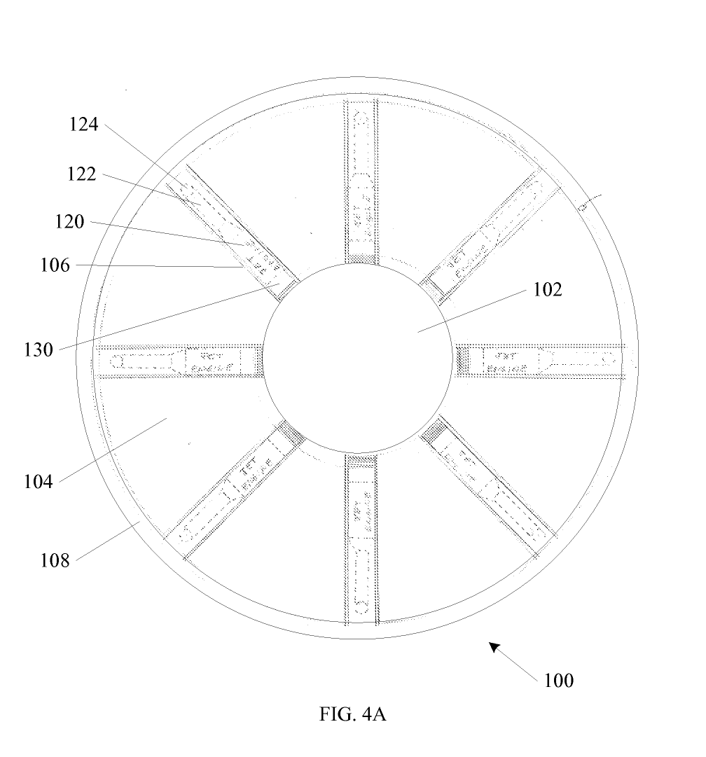

FIG. 3 illustrates one method of operation of the agricultural spray system 200 of FIG. 2. In operation 302, an agricultural area is sprayed using a mapping airship, such as airship 230 from FIG. 2. In operation 304, selected areas of the agricultural area requiring a higher amount of an agricultural supply than other areas within the agricultural area are mapped. In operation 306, the agricultural product is sprayed over the selected areas using an autonomous spray airship.

In one example, the mapping airship is operated during the day, and the spraying of the agricultural product is accomplished at night. In one example, spraying at night includes advantages such as lower evaporation of the applied agricultural product. The mapping airship may use a number of criteria to create the map for use in spraying. In one example a color of areas of an area are mapped. In one example percent humidity is mapped. In one example, temperature data is mapped. Although a number of example criteria are listed, the invention is not so limited. Other differentiating criteria may be mapped in order to determine which areas of a field are in greater need of an agricultural product.

By mapping and selectively spraying an agricultural product, a number of advantages are provided. Less agricultural product is used in targeted application, therefore costs are reduced. Using an herbicide or pesticide example, strong chemical applications are reduced to only in needed areas. This may result in reduction in strong chemicals that may be washed into adjacent waterways. Examples of targeted areas include, but are not limited to, insect affected areas, dry areas in need of water, areas with invasive weeds, areas with differing soil conditions and/or nutrient content, etc.

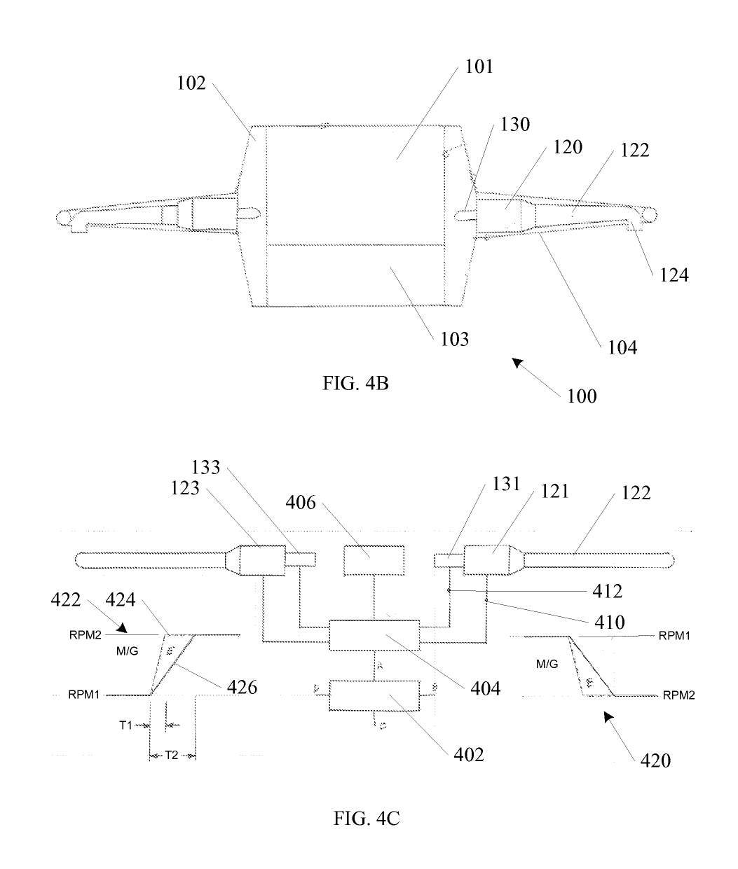

FIG. 4A shows a top view of the airship 100 from FIG. 1. The airship 100 includes a plurality of turbine thrusters 120. The airship 100 also includes a plurality of electric motor/generators 130 coupled to the plurality of turbine thrusters 120. The body portion 102 is shown in a center of the airship 100, and may house one or more reservoirs and/or operational circuitry. The periphery 104 is shown housing the plurality of turbine thrusters 120. In the example shown, eight turbine thrusters 120 are used, however other examples may include a larger or smaller number of turbine thrusters 120. In one example, the turbine thrusters 120 are coupled in pairs, as discussed in greater detail below.

In the example shown, the turbine thrusters 120 are located within bulkhead frame members 106. This configuration allows easy mounting of the turbine thrusters 120, and provides structural integrity to the periphery 104. In one example, a tubular structure 108 further provides structural integrity to the periphery, with minimal weight. In one example, an aluminum skin, or other suitable material, is used to cover frame elements, such as bulkhead frame members 106 and tubular structure 108.

In one example, the turbine thrusters 120 are fueled by diesel fuel that is stored in a reservoir located in the body portion 102. Although diesel fuel is contemplated in one example, the invention is not so limited. Other fuels, such as jet fuel, octane, etc. may be used without departing from the scope of the invention.

A number of ducts 122 and nozzles 124 are shown coupled to the turbine thrusters 120 to direct the thrust downward and provide lift and navigational thrust to the airship 100. Also shown are a number of electric motor/generators 130 coupled to the turbine thrusters 120. In one example, the electric motor/generators 130 are directly coupled to a drive shaft of the turbine thrusters 120, although an indirect connection through a mechanical coupling such as a chain, gear train, etc. is also within the scope of the invention.

FIG. 4B shows a side view of the airship 100, with the turbine thrusters 120, ducts 122, and nozzles 124 shown. The electric motor/generators 130 are shown coupled to a back side of each of the turbine thrusters 120. FIG. 4B further shows a number of reservoirs located in the body portion 102. In the example of FIG. 4B, a first reservoir 101 may include fuel for the turbine thrusters 120, while a second reservoir 103, may include an agricultural product as discussed above.

During flight, when a thrust adjustment is needed, a throttle on one or more of the turbine thrusters 120 may have a slow response time lag from when a throttle change is made to when a difference in thrust is realized. In one example, the electric motor/generators 130 are used to supplement thrust from the turbine thrusters 120 to provide a faster response time for variations in thrust.

FIG. 4C illustrates one configuration used to supplement thrust. An axis controller 404 is shown coupled to throttles of the turbine thrusters 120 by connections 410. The axis controller 404 is further coupled to the electric motor/generators 130 by connections 412. A flight controller 402 is shown coupled to the turbine thrusters 120 and the electric motor/generators 130 through the axis controller 404, although the invention is not so limited. A sensor 406, such as a tilt sensor, is configured to collect and provide current orientation data to the axis controller 404 and flight controller 402.

In one example the flight controller 402 may provide input to tilt the airship 100, and as a result, the axis controller 404 may initiate the desired motion direction and speed. If a hovering condition is desired, the axis controller 404 may receive orientation and location data from the sensor 406 and merely provide adjustments to thrust as needed to maintain a steady orientation and location.

In one example, opposite turbine thrusters 120 and electric motor/generators 130 are paired. In FIG. 4C, a first turbine thruster 121 and first electric motor/generator 131 is paired to a second turbine thruster 123 and second electric motor/generator 133. If a tilt is desired towards the first turbine thruster 121, the first turbine thruster 121 will decrease throttle, and the second turbine thruster 123 will increase throttle. To supplement any time lag in the throttle changes, an amount of generated electricity from the first electric motor/generator 131 is transferred to the second electric motor/generator 133. In this operation, the first electric motor/generator 131 is primarily functioning as a generator, and the second electric motor/generator 133 is primarily functioning as a motor.

This operation is illustrated by graph 420 that indicates thruster RPM for the first turbine thruster 121, and graph 422 that indicates thruster RPM for the second turbine thruster 123. In graph 422, the time lag T2 for the second turbine thruster 123 is shown by the time needed for line 426 to go from RPM1 to RPM2. When the electricity from the first electric motor/generator 131 is transferred to the second electric motor/generator 133, the additional power indicated by line 424 provides the necessary RPM2 (and resulting thrust) in a shorter time T1.

Because the electric motor/generators 130 have a faster response time that the throttles on the turbine thrusters 120, a change in thrust can be accomplished much more quickly than with a throttle adjustment alone. Additionally, because the electric motor/generators 130 are being powered by fuel driven turbine thrusters 120, they will have a much greater operating time, due to efficiencies over electric only configurations, such as a solely battery powered airship.

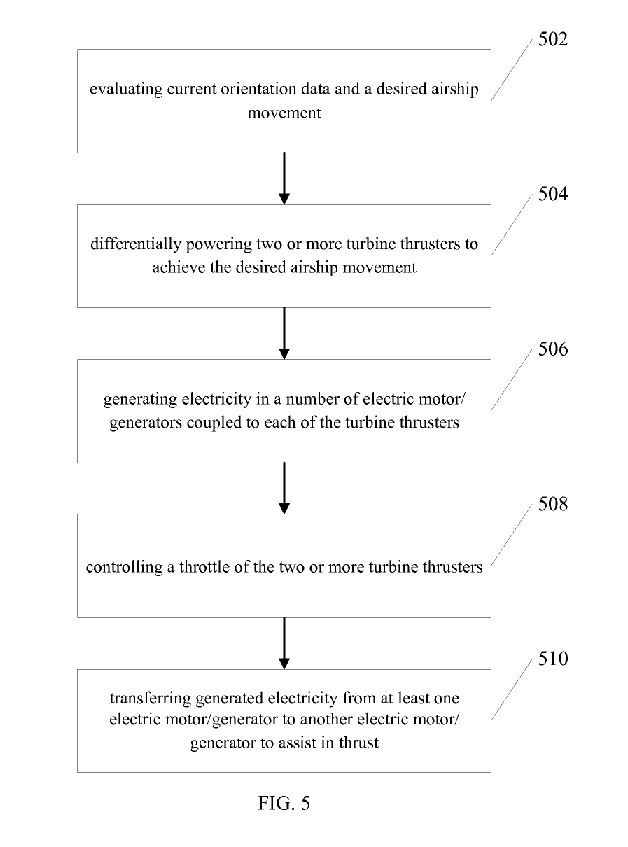

FIG. 5 shows an example method of controlling an airship, similar to the method described above. In operation 502, current orientation data and a desired airship movement are evaluated. In one example, circuitry such as the sensor 406 and the flight controller may provide data such as the current orientation and the desired airship movement. In operation 504, two or more turbine thrusters are differentially powered to achieve the desired airship movement. Operations 506, 508, and 510 describe in more detail the operation of powering two or more turbine thrusters. In operation 506, electricity is generated in a number of electric motor/generators coupled to each of the turbine thrusters. In operation 508, a throttle of the two or more turbine thrusters is controlled. In operation 510, generated electricity is transferred from at least one electric motor/generator to another electric motor/generator to assist in thrust.

To better illustrate the method and device disclosed herein, a non-limiting list of embodiments is provided here:

Example 1 includes an airship, having a plurality of turbine thrusters, a plurality of electric motor/generators coupled to the plurality of turbine thrusters, and a flight controller coupled to a throttle of each of the plurality of turbine thrusters and coupled to each of the plurality of electric motor/generators, wherein the flight controller is configured to transfer power from at least one electric motor/generator to another electric motor/generator to assist in thrust.

Example 2 includes the airship of example 1, wherein the flight controller is programmed to be autonomous.

Example 3 includes the airship of any one of examples 1-2, further including a liquid payload reservoir.

Example 4 includes the airship of any one of examples 1-3, wherein the plurality of turbine thrusters include diesel fuel powered turbine thrusters.

Example 5 includes the airship of any one of examples 1-4, wherein the plurality of turbine thrusters includes eight turbine thrusters.

Example 6 includes an agricultural spray system. The agricultural spray system includes an airship, having a plurality of turbine thrusters, a plurality of electric motor/generators coupled to the plurality of turbine thrusters, and a flight controller coupled to a throttle of each of the plurality of turbine thrusters and coupled to each of the plurality of electric motor/generators, wherein the flight controller is configured to transfer power from at least one electric motor/generator to another electric motor/generator to assist in thrust. The example agricultural spray system includes an airship reservoir coupled to the airship to hold an agricultural product an autonomous navigational control system coupled to the airship, and a docking station adapted to couple to the airship, the docking station including a second reservoir, larger than the airship reservoir.

Example 7 includes the agricultural spray system of example 6, wherein the docking station is included in a wheeled trailer.

Example 8 includes the agricultural spray system of any one of examples 6-7, wherein the docking station is configured to accept a pair of airships.

Example 9 includes the agricultural spray system of any one of examples 6-8, further including a mapping airship configured to map selected area of a field for targeted spraying, wherein the flight controller is configured to receive targeted spraying data from the second airship.

Example 10 includes a method of controlling an airship, including evaluating current orientation data and a desired airship movement, and differentially powering two or more turbine thrusters to achieve the desired airship movement, wherein powering two or more turbine thrusters includes generating electricity in a number of electric motor/generators coupled to each of the turbine thrusters, controlling a throttle of the two or more turbine thrusters, and transferring generated electricity from at least one electric motor/generator to another electric motor/generator to assist in thrust.

Example 11 includes the method of example 10, wherein transferring generated electricity includes transferring generated electricity from a first electric motor/generator requiring decreased thrust to a second electric motor/generator on an opposite side of the airship from the first electric motor/generator, the second electric motor/generator requiring increased thrust.

Example 12 includes the method of any one of examples 10-11, wherein powering two or more turbine thrusters includes powering eight turbine thrusters.

Example 13 includes the method of any one of examples 10-12, wherein powering eight turbine thrusters includes powering eight turbine thrusters substantially equally spaced around a circumference of a circular airship.

Example 14 includes a method of agricultural spraying, including surveying an agricultural area using a mapping airship, mapping selected areas of the agricultural area requiring a higher amount of an agricultural product than other areas within the agricultural area, and spraying the agricultural product over the selected areas using an autonomous spray airship.

Example 15 includes the method of example 14, wherein mapping selected areas of the agricultural area includes mapping a color of selected areas of the agricultural area.

Example 16 includes the method of any one of examples 14-15, wherein spraying the agricultural product over the selected areas includes spraying an insecticide.

Example 17 includes the method of any one of examples 14-16, wherein spraying the agricultural product over the selected areas includes spraying an herbicide.

Example 18 includes the method of any one of examples 14-17, wherein spraying the agricultural product over the selected areas includes spraying at night time.

Example 19 includes the method of any one of examples 14-18, wherein surveying an agricultural area includes surveying an agricultural area during day time.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. An airship, comprising:
a plurality of turbine thrusters;
a plurality of electric motor/generators coupled to the plurality of turbine thrusters; and
a flight controller coupled to a throttle of each of the plurality of turbine thrusters and coupled to each of the plurality of electric motor/generators, wherein the flight controller is configured to transfer power from at least one electric motor/generator to another electric motor/generator to assist in thrust.

2. The airship of claim 1, wherein the flight controller is programmed to be autonomous.

3. The airship of claim 1, further including a liquid payload reservoir.

4. The airship of claim 1, wherein the plurality of turbine thrusters include diesel fuel powered turbine thrusters.

5. The airship of claim 1, wherein the plurality of turbine thrusters includes eight turbine thrusters.

6. An agricultural spray system, comprising:
an airship, including:
a plurality of turbine thrusters;
a plurality of electric motor/generators coupled to the plurality of turbine thrusters;
a flight controller coupled to a throttle of each of the plurality of turbine thrusters and coupled to each of the plurality of electric motor/generators, wherein the flight controller is configured to transfer power from at least one electric motor/generator to another electric motor/generator to assist in thrust;
an airship reservoir coupled to the airship to hold an agricultural product;
an autonomous navigational control system coupled to the airship; and
a docking station adapted to couple to the airship, the docking station including a second reservoir, larger than the airship reservoir.

7. The agricultural spray system of claim 6, wherein the docking station is included in a wheeled trailer.

8. The agricultural spray system of claim 6, wherein the docking station is configured to accept a pair of airships.

9. The agricultural spray system of claim 6, further including a mapping airship configured to map selected area of a field for targeted spraying, wherein the flight controller is configured to receive targeted spraying data from the second airship.

10. A method of controlling an airship, comprising:
evaluating current orientation data and a desired airship movement;
differentially powering two or more turbine thrusters to achieve the desired airship movement;
wherein powering two or more turbine thrusters includes;
generating electricity in a number of electric motor/generators coupled to each of the turbine thrusters;
controlling a throttle of the two or more turbine thrusters; and
transferring generated electricity from at least one electric motor/generator to another electric motor/generator to assist in thrust.

11. The method of claim 10, wherein transferring generated electricity includes transferring generated electricity from a first electric motor/generator requiring decreased thrust to a second electric motor/generator on an opposite side of the airship from the first electric motor/generator, the second electric motor/generator requiring increased thrust.

12. The method of claim 10, wherein powering two or more turbine thrusters includes powering eight turbine thrusters.

13. The method of claim 10, wherein powering eight turbine thrusters includes powering eight turbine thrusters substantially equally spaced around a circumference of a circular airship.

14. A method of agricultural spraying, comprising:
surveying an agricultural area using a mapping airship;
mapping selected areas of the agricultural area requiring a higher amount of an agricultural product than other areas within the agricultural area; and
spraying the agricultural product over the selected areas using an autonomous spray airship.

15. The method of claim 14, wherein mapping selected areas of the agricultural area includes mapping a color of selected areas of the agricultural area.

16. The method of claim 14, wherein spraying the agricultural product over the selected areas includes spraying an insecticide.

17. The method of claim 14, wherein spraying the agricultural product over the selected areas includes spraying an herbicide.

18. The method of claim 14, wherein spraying the agricultural product over the selected areas includes spraying at night time.

19. The method of claim 18, wherein surveying an agricultural area includes
surveying an agricultural area during day time.
